(19) United States
(12) Patent Application Publication
(10) Pub. No.: US 2008/0026319 A1
(43) Pub. Date: Jan. 31, 2008

(54) LASER MARKING OF COATED ARTICLES AND LASER-MARKABLE COATING COMPOSITION

(76) Inventors: Lawrence J. Stroh III, Seffner, FL (US); Thomas M. Gaffney, Lutz, FL (US)

Correspondence Address: HARNESS, DICKEY & PIERCE, P.L.C., P.O. BOX 828, BLOOMFIELD HILLS, MI, 48303, US

(21) Appl. No.: 11/763,149

(22) Filed: Jun. 14, 2007

Related U.S. Application Data
(60) Provisional application No. 60/814,009, filed on Jun. 15, 2006.

(51) Int. Cl. G03C 1/00

(52) U.S. Cl. 430/270.1

(57) ABSTRACT

A method of marking a coating includes incorporating into a powder coating composition a laser-reactive material; forming a coating layer on an article with the coating composition, and marking the coating on the article with a laser. The marking can be printing, a graphic, a design, a log, information, symbols, and so on, as well as combinations of such markings.

### CROSS-REFERENCE TO RELATED APPLICATIONS

This application claims the benefit of U.S. Provisional Application No. 60/814009 filed on Jun. 15, 2006. The disclosure of the above application is incorporated herein by reference.

### FIELD

The present disclosure relates to marking or printing articles with words or graphics. The present disclosure also relates to powder coating compositions and methods of coating articles with those compositions.

### BACKGROUND

The statements in this section merely provide background information related to the present disclosure and may not constitute prior art.

Screen printing or attaching a decal is sometimes used for a painted article to apply a design, contrasting print, or other markings. In particular, with screen printing, unlike with decals, attaining and maintaining adhesion is seldom a concern. A screen printed design or other markings, however, requires many extra manufacturing steps, including preparing the screen, applying the second coating, and drying or curing the applied coating. A printed design can also wear away over time or be removed by cleaning solvent, resulting in loss of information or brand identification.

### SUMMARY

A method of marking a coating includes incorporating into a powder coating composition a laser-reactive material; forming a coating layer on an article with the coating composition; and marking the coating on the article with a laser. The marking can be printing, a graphic, a design, a log, information, symbols, and so on, as well as combinations of such markings.

The powder coating composition includes a laser-reactive material. “Laser-reactive” refers to a material that absorbs energy from a laser beam, with the absorbed energy causing the material to undergo a chemical change that manifests in a color change or color shift. The laser-reactive material, if of suitably fine particle size, may be dry-blended with an already-prepared powder coating composition. The laser-reactive material may, alternatively or additionally, be incorporated during preparation of the powder coating composition so that it is present within the powder coating particles. In this method, the laser-reactive material is applied to the article concurrently with the powder coating composition. A coating layer is formed from the applied powder coating composition, e.g. with heat the composition coalesces and, optionally cures into a coating layer. The coating layer is then marked with a laser beam.

In a second method, a composition containing the laser-reactive material may be applied in a thin layer over a cured coating on an article or after a coating composition is applied to the article but before baking or curing of the coating composition. The composition containing the laser-reactive material may be a liquid composition or a powder coating composition. The composition containing the laser-reactive material can be transparent and can, additionally, be colorless. The article is then marked with a laser beam in the area where the composition containing the laser-reactive material was applied.

In a third method, a composition containing the laser-reactive material may be applied in a thin layer over a cured or dried coating on an article or over an uncured coating layer which is then cured after the composition containing the laser-reactive material is applied. Again, the composition containing the laser-reactive material may be a liquid composition or a powder coating composition. The composition containing the laser-reactive material may be applied over only a particular area of the coating on the article. The article is then marked with a laser beam in the area where the composition containing the laser-reactive material was applied.

The marking produced by the processes will not rub off like printing ink or peel off like a label. The color of the mark can be selected, depending on the particular laser-reactive additive chosen, the amount of laser-reactive additive used, the type of laser and time of exposure to the laser beam, and other such factors that will become apparent from this disclosure.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring such parameters. In addition, disclosure of ranges includes disclosure of all values and further divided ranges within the entire range.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIGS. 1a and 1b illustrate a graphic marked with a laser beam on, respectively, a yellow powder-coated steel saw blade and a yellow powder-coated steel hole saw blade;

FIGS. 2a and 2b illustrate graphics and information marked with a laser beam on, respectively, a circular saw blade and steel jig saw blades coated with clear powder coating;

FIGS. 3a and 3b illustrate graphics and information marked with a laser beam on plastic housings for, respectively, a reciprocating saw and a drill coated with yellow powder coating; and

FIGS. 4a through 4h are illustrations of marked articles prepared in Examples 1 to 8.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In a first method, a powder coating composition comprises a film-forming material and a laser-reactive additive.

The laser-reactive additives absorb energy from laser light to change color or shade. Non-limiting examples of laser-reactive additives are antimony-doped tin oxide, metal oxide-coated micas including metal-doped metal oxide-coated micas, clays, talc, kaolins, chalks, aluminas, phyllosilicates, carbon black, salts of antimony, copper, and other metals such as antimony (III) oxide, metallic pigments such as aluminum flake pigments, and pearlescent pigments. The laser-reactive additive may be included in the powder coating composition in amounts from about 0.01, preferably from about 0.1, more preferably from about 1 percent by weight and up to about 20, preferably up to about 15, more preferably up to about 10, and still more preferably up to about 6 percent by weight, based on the total weight of the powder coating composition. The amount of the laser-reactive additive present in the powder coating composition may be in a range of any combination of these values inclusive of the recited values.

Examples of suitable, commercially available laser-reactive additives include, without limitation, MARK-IT™ pigments available from Englehard, PACKMARK, CASEMARK, GUARDMARK, FOODMARK, and PHARMAMARK pigments available from DataLase, FAST-MARK pigment available from Polyone Corporation, CerMark pigment available from Cerdec Corporation, and Lazerflair® pigments available from EMD Chemicals (Merck KGaA).

The powder coating further includes one or more film-forming materials, optionally one or more pigments, and, if desired, one or more additives other than pigments. The film-forming materials of the powder coating composition may be any of the polymers known to be useful in powder coating compositions. Preferably, the film-forming materials are thermosetting (i.e., curable) materials, but thermoplastic film-forming materials can be used instead or in combination with thermosetting materials. The film-forming materials can be selected from polymers having reactive functional groups and generally curing agents reactive with those functional groups are also included. The polymer having reactive functional groups can be chosen from a variety of materials, including, but not limited to, acrylic polymers, polyurethanes, polyethers, cellulosics, epoxy polymers and oligomers, polyesters, alkyds, and combinations of these. The reactive functional groups on the polymer or oligomer may include, but are not limited to, carboxylic acid groups, anhydride groups, epoxide groups, hydroxyl groups, amino groups, carbamate groups, urea groups and compatible combinations of these. Compatible combination of reactive groups are those combinations that do not react together during preparation of the powder coating.

The powder coating film-forming polymers generally have a glass transition temperature (T_{g}) of 30° C., or higher more preferably 40° C. or higher. The T_{g} of the polymer contributes to the stability of the powder coating composition. The higher the T_{g} of the polymer, the better the stability of the coating, but the coating may require higher baking temperatures or longer curing times. The T_{g} is described in PRINCIPLES OF POLYMER CHEMISTRY (1953), Cornell University Press. The T_{g} can be measured or it can be calculated (e.g., for acrylic polymers as described by Fox in Bull. Amer. Physics Soc., 1, 3 page 123 (1956)). The actual measured values for T_{g} are obtainable by differential scanning calorimetry (DSC), where the T_{g} is taken at the first inflection point. Also, the T_{g} can be measured experimentally by using a penetrometer such as a DuPont 940 Thermomedian Analyzer. The T_{g} of the polymers as used herein for this invention refers to the calculated values unless otherwise indicated.

A polymer having as reactive functional groups carboxylic acid groups may be combined with a curing agent or crosslinking agent having epoxide groups, oxazoline groups, or an aminoplast or phenoplast curing agent. A polymer having as reactive functional groups carboxylic acid anhydride groups may be combined with a curing agent having epoxide or groups or hydroxyl groups. A polymer having as reactive functional groups epoxide groups may be combined with a curing agent having carboxylic acid groups, acid anhydride groups, or amino groups. A polymer having as reactive functional groups hydroxyl groups may be combined with a curing agent having anhydride groups, isocyanate groups (particularly blocked isocyanate groups), or an aminoplast or phenoplast curing agent. A polymer having as reactive functional groups amino groups, carbamate groups, or urea groups may be combined with a curing agent having anhydride groups, epoxide groups, isocyanate groups (e.g., blocked isocyanate groups), or an aminoplast or phenoplast curing agent. These polymer and/or curing agents may also be used in compatible combinations. Other combinations of film-forming polymers and curing agents are possible and known in the art; the disclosure of particular examples should in no way be interpreted as any limitation on the application of the present methods or their usefulness. The film-forming material may also be or include a thermoplastic polymer, for example, polyethylene, polypropylene, polyamide, or polyester.

Examples of epoxy resins include bisphenol A- and F-type epoxy resins, novolac epoxy resins, and alicyclic epoxy resins. Examples of suitable epoxy resins also include: triglycidyl isocyanurate; trimellitic acid triglycidyl ester; hexahydrotrimellitic acid triglycidyl ester; solid mixed phases comprising a first component selected from trimellitic acid triglycidyl ester, hexahydrotrimellitic acid triglycidyl ester and mixtures of trimellitic acid triglycidyl ester and hexahydrotrimellitic acid triglycidyl ester, and a second component selected from terephthalic acid diglycidyl ester, hexahydroterephthalic acid diglycidyl ester and mixtures of terephthalic acid diglycidyl ester and hexahydroterephthalic acid diglycidyl ester; epoxyphenol novolacs; epoxycresol novolacs and mixtures of two or more of these resins. Examples of commercial bisphenol A epoxy resins are Epikote 1055 (available from Shell), Epon resins (available from Dow) and Araldite GT 7004 (available from Ciba Chemicals). Typically, the epoxy resin may have an epoxide equivalent weight from 400 to 3000.

The polymer having reactive functional groups may be vinyl polymer, including an acrylic polymer. Vinyl polymers containing the appropriate functional groups can be formed by reacting polymerizable alpha, beta-ethylenically unsaturated monomers containing the functional groups mentioned above with one or more other polymerizable, unsaturated monomers. Suitable copolymerizable monomers include olefinic unsaturated monomers such as ethylene, propylene and isobutylene, aromatic monomers such as styrene, vinyltoluene and alpha-methyl styrene, esters of acrylic acid and methacrylic acid with alcohols having 1 to 18 carbon atoms such as methyl acrylate, methyl methacrylate, ethyl acrylate, ethyl methacrylate, propyl acrylate, propyl methacrylate, n-butyl acrylate, n-butyl methacrylate, isobutyl acrylate, isobutyl methacrylate, cyclohexyl acrylate, cyclohexyl methacrylate, 2-ethylhexyl acrylate, 2-ethylhexyl methacrylate, lauryl acrylate and lauryl methacrylate, vinyl esters of carboxylic acids having 2 to 11 carbon atoms such as vinyl acetate, vinyl propionate and vinyl 2-ethylhexylacrylate and other co-monomers such as vinyl chloride, acrylonitrile and methacrylonitrile. These co-monomers can be used singly or as a mixture of two or more of them. Hydroxy-functional acrylic polymers may be formed by reaction of the copolymerizable monomer with hydroxyethyl acrylate, hydroxybutyl acrylate, hydroxybutyl methacrylate, hydroxypropyl acrylate and the like. Amino functional acrylic monomers include aminoethyl methacrylate, aminopropyl methacrylic, t-butylaminoethyl methacrylate and t-butylaminoethylacrylate. Carboxy functional groups may be incorporated into an acrylic polymer by reaction with acrylic acid, methacrylic acid, crotonic acid, itaconic acid, maleic acid, fumaric acid, citraconic and monoesters of polymerizable, unsaturated dicarboxylic acids with monohydric alcohols. Ethylenically unsaturated monomers containing epoxide groups include glycidyl acrylate, glycidyl methacrylate, 3,4-epoxycyclohexylmethyl(meth)acrylate; 2-(3,4-epoxycyclohexyl)ethyl (meth)acrylate and allyl glycidyl ether. Pendant carbamate functional groups can be incorporated into the acrylic polymer by copolymerizing the acrylic monomers with a carbamate functional vinyl monomer. Examples of suitable carbamate functional monomers include: (a) carbamate functional alkyl esters of methacrylic acid; (b) the reaction product of hydroxyethyl methacrylate, isophorone diisocyanate, and hydroxypropyl carbamate; (c) the reaction product of hydroxypropyl methacrylate, isophorone diisocyanate, and methanol; and (d) the reaction product of isocyanic acid with a hydroxyl functional acrylic or methacrylic monomer like hydroxyethyl acrylate. Pendant urea groups can be incorporated into the acrylic polymer by copolymerizing the acrylic monomers with urea functional vinyl monomers. Examples of urea functional monomers include: (a) urea functional alkyl esters of acrylic acid or methacrylic acid and (b) the reaction product of hydroxyethyl methacrylate, isophorone diisocyanate, and hydroxyethyl ethylene urea.

The vinyl polymers have equivalent weights (based on the functional groups mentioned above) of about 200 to 400 or 250 to 355 grams/equivalent. The glass transition temperature (T_{g}) of the polymer is typically about 30° C. to 60° C. or 35° C. to 55° C.

The polymer having reactive groups may be a polyester polymer having the functional groups mentioned above. Polyester polymers are based on a condensation reaction of low molecular weight aliphatic polyols, including cycloaliphatic polyols, with aliphatic and/or aromatic polycarboxylic acids and anhydrides. Non-limiting examples of polycarboxylic acids and acid anhydrides include phthalic acid, phthalic anhydride, isophthalic acid, terephthalic acid, tetrahydrophthalic acid, hexahydrophthalic acid, tetrachlorophthalic anhydride, hexahydrophthalic anhydride, pyromellitic anhydride, trimellitic acid, succinic acid, azelaic acid, sebacic acid, dodecanoic acid, and adipic acid. Non-limiting examples of useful polyols are ethylene glycol, caprolactone diols, diethylene glycol, triethylene glycol, propylene glycol, dipropylene glycol, 1,3-propanediol, 1,4-butanediol, 1,6-hexanediol, cyclohexane dimethanol, glycerin, trimethylolpropane, pentaerythritol, neopentyl glycol and hydrogenated bisphenol A. Polymeric polyols such as the polyether polyols mentioned above can be used in combination with the low molecular weight polyols. Carboxylic acid functionality can be introduced into the polyester by reacting a stoichiometric excess of the polycarboxylic acid with the polyol. Examples of commercial carboxy-functional polyesters are: Uralac P3560 (from DSM Resins) and Crylcoat 314 (from UCB Chemicals). Hydroxyl functionality can be incorporated into the polyester by reacting a stoichiometric excess of the polyol component with the polycarboxylic acid. Examples of commercial hydroxy-functional polyesters are: Uralac P5504 (from DSM Resins) and Alftalat AN 739 (from Vianova Resins). Epoxy groups can be introduced into the polyester by including an epoxy functional compound such as glycidol with the polyol component. Amino groups can be introduced into the polyester by including an amino alcohol such as amino ethanol or amino propanol with the polyol component. Pendant carbamate groups can be introduced into the polyester by forming a hydroxyalkyl carbamate which can be reacted with the polyacids or polyols used to form the polyester. Pendant urea groups can be introduced into the polyurethane by reacting a hydroxyl functional urea such as hydroxyalkyl ethylene urea with the polyacids and polyols used to form the polyester. Also, polyester prepolymers can be reacted with primary amines, aminoalkyl ethylene urea, or hydroxyalkyl ethylene urea to yield a material with pendant urea groups.

The polyester polymers typically have number average molecular weights of about 1,000 to 35,000 or 2,000 to 10,000 based on gel permeation chromatography using a polystyrene standard. The polyester polymers may have equivalent weights (based on the functional groups mentioned above) of about 280 to about 2,805, in some embodiments about 122 to about 1,870 gram/equivalent. The T_{g} of the polymer is typically about 25° C. to about 85° C., in some embodiments about 50° C. to about 70° C.

In another embodiment of the present invention, the polymer having reactive functional groups is a polyurethane polymer containing at least one of the functional groups mentioned above for the vinyl polymers. Polyurethane polymers can be prepared by reacting polyols and polyisocyanates. Examples of suitable polyols include low molecular weight aliphatic polyols such as ethylene glycol, propylene glycol, butylene glycol, 1,6-hexylene glycol, neopentyl glycol, cyclohexanedimethanol, trimethylolpropane and the like. Typically, high molecular weight polymeric polyols such as polyether polyols and polyester polyols are used with the lower molecular weight polyols. Examples of polyether polyols are those formed from the oxyalkylation of various polyols like glycols or higher polyols. Suitable glycols include ethylene glycol, 1,6-hexanediol, and Bisphenol A. Suitable higher polyols include trimethylolpropane and pentaerythritol. Suitable polyester polyols can be prepared as the hydroxyl-functional polyesters already described. Usually, the polycarboxylic acids and polyols are aliphatic or aromatic dibasic acids and diols. Suitable polyisocyanates include aromatic and aliphatic polyisocyanates. Aliphatic polyisocyanates are preferred because of their exterior durability. Exemplary polyisocyanates include 1,6-hexamethylene diisocyanate, isophorone diisocyanate and 4,4′-methylene-bis-(cyclohexyl isocyanate). Carboxylic acid functionality can be introduced into the polyurethane by reacting the polyurethane polyol with polycarboxylic acids. Exemplary polycarboxylic acids include succinic acid, adipic acid, azelaic acid, sebacic acid, terephthalic acid, isophthalic acid, tetrahydrophthalic acid, hexahydrophthalic acid, trimellitic acid and anhydrides of such acids. Alternatively, the polyisocyanate can be reacted with a mixture of the polyols mentioned above and a polyol containing carboxylic acid groups such as dimethylolpropionic acid. Hydroxyl functionality can be introduced into the polyurethane by reacting the polyisocyanate with a stoichiometric excess of the polyol component to form a polyurethane polyol. Epoxy functionality can be incorporated into the polyurethane by including a hydroxy functional epoxy compound like glycidol with the polyol component. Amino functionality can be introduced into the polyurethane by including a polyamine in the monomer charge. Suitable amines include primary and secondary diamines and polyamines in which the radicals attached to the nitrogen atoms are saturated, aliphatic, alicyclic, aromatic, aromatic-substituted aliphatic, aliphatic-substituted aromatic, or heterocyclic. Pendant carbamate groups can be incorporated into the polyurethane by forming a hydroxyalkyl carbamate which can be reacted with the polyacids or polyols used to form the polyurethane. Pendant urea groups can be introduced into the polyurethane by reacting a hydroxyl functional urea such as hydroxyalkyl ethylene urea with the polyacids and polyols used to form the polyurethane. Also, isocyanate terminated polyurethane can be reacted with primary amines, aminoalkyl ethylene urea, or hydroxyalkyl ethylene urea to yield a material with pendant urea groups.

The polyurethane polymers typically have number average molecular weights of about 3,000 to 25,000 or in some embodiments about 5,000 to 10,000 based on gel permeation chromatography using a polystyrene standard. The polyurethane polymers have equivalent weights (based on the functional groups mentioned above) of about 280 to 2,805 or in some embodiments about 1,122 to 1,870 gram/equivalent. The T_{g} of the polymer is typically about 35° C. to 85° C. or in some embodiments 45° C. to 60° C.

The polymers having reactive functional groups may be used in any compatible combination, such as epoxy/polyester mixtures and polyester/polyacrylate mixtures.

The powder coating composition of the present invention also comprises a curing agent having functional groups that are reactive with the functional groups of the polymer described above. Suitable curing agents include polyepoxides, beta-hydroxyalkylamides, polyacids, aminoplasts, and blocked polyisocyanates. Suitable curing agents for an epoxide-functional polymer include, without limitation, polyamines, bicyclic guanidines, acid anhydride curing agents, polyphenol curing agents, anionic and cationic polymerization catalytic curing agents, and combinations of these. Representative examples include, but are not limited to, dicycandiamide and its derivatives; acid anhydrides such as phthalic anhydride, trimellitic anhydride, pyromellitic anhydride, hexahydrophthalic anhydride, maleic anhydride and succinic anhydride; aromatic polyamines, such as ethylenediamine, meta-phenylenediamine, diethyltoluenediamine, methylene bis(2,6-dimethylaniline), tris(dimethylaminomethyl)phenol, 4-4′-diaminodiphenylmethane, 4,4′-diaminodiphenyl sulfone, 4,4′-diaminodiphenyl ether, and 3-phenyl-1,1-dimethyl urea; imidazole, 1-methylimidazole, 1,2-dimethylimidazole, 2-methylimidazole, 2-heptadecylimidazole, 2-ethyl-4-methylimidazole, 2-undecylimidazole, and 1-(2-cyanoethyl)-2-phenylimidazole; and dihydrazide. Commercially available imidazole-arylene polyamine mixtures can be used; such as those mixtures containing arylene polyamines with a high degree of alkyl substitution on the aromatic ring, typically at least three such substituents.

Crosslinking agents for the hydroxyl-functional polymers include acid anhydrides, such as pyromellitic anhydride, trimellitic anhydride, phthalic anhydride, and succinic anhydride; aminoplasts; glycolurils; and blocked aliphatic and aromatic polyisocyanates, such as benzene triisocyanate, polymethylene isocyanate, 1,4-tetramethylene diisocyanate, 1,6-hexamethylene diisocyanate, 4,4′-diphenylmethane diisocyanate, 1,3-phenylene diisocyanate, 1,4-phenylene diisocyanate, toluene diisocyanate, 1,4-cyclohexyl diisocyanate, isophorone diisocyanate, and 4,4′-methylene-bis(cyclohexyl isocyanate) blocked hexamethylene diisocyanate, and polymethylene polyphenylisocyanate, particularly oligomers of these such as isocyanurates and biurets, and versions of these in which the isocyanate groups have been blocked. A particularly preferred class of aminoplast resins include aldehyde condensates of glycoluril, such as those described above. Glycoluril resins suitable for use as the adjuvant curing agent in the powder coating compositions of the invention include POWDERLINK® 1174 commercially available from Cytec Industries, Inc. of Stamford, Conn.

Preferable blocking agents for reaction with polyisocyanates are oximes, such as methylethyl ketoxime, methyl-n-amyl ketoxime, acetone oxime, cyclohexanone oxime and caprolactam. Other blocking agents include malonic esters and any suitable aliphatic, cycloaliphatic, aromatic and alkyl monoalcohols. Additional blocking agents include the lower aliphatic alcohols such as methyl, ethyl, chloroethyl, propyl, butyl, amyl, hexyl, heptyl, octyl, nonyl, 3,3,5-trimethylhexanol, decyl and lauryl alcohols, and the like. Examples of aromatic-alkyl alcohols, include phenylcarbinol, ethylene glycol monoethyl ether, monobutyl ether, monopropyl ether and the like. Other blocking agents are phenolic compounds such as phenol itself and substituted phenols where the substituents do not adversely affect the coating operations including cresol, nitrophenol, chlorophenol and t-butyl phenol. Also suitable are dibutyl amine and tertiary hydroxyl amines such as diethylethanolamine. Examples of commercial isocyanates are Vestagon B1530, Vestanat T1890 (both available from Creanova) and Bayhydur 3100 (available from Bayer).

Nonlimiting examples of suitable curing agents for acid-functional polymers are polyepoxide materials, polyoxazolines and polydioxanes, beta-hydroxyalkylamides such as Primid XL-552 (EMS), or a polyoxazoline like 1,4-phenylene-bis(2-oxazoline) but also a polymer containing oxazoline functional groups. This polymer can for example be a polyester or polyacrylate. Examples of commercially available oxazoline functional polymers also include Epocros K-1000, K-2000, WS-500 (all available from Nippon Shokubai)

Examples of suitable crosslinking agents from epoxide-functional polymers include polycarboxylic acids and their anhydrides such as phthalic acid, phthalic anhydride, trimellitic anhydride and pyromellitic anhydride; polyphenols such as catechol, resorcinol, hydroquinone, pyrogallol and fluoroglumine; and polyamines such as ethylenediamine, meta-phenylenediamine, 4-4′-diaminodiphenylmethane, 4,4′-diaminodiphenyl sulfone and 4,4′-diaminodiphenyl ether.

Aminoplast and phenoplast curing agents are suitable curing agents for polymers having hydroxyl, carboxylic acid, carbamate and urea functional groups.

Such resin combinations may be selected so as to be co-curing, for example, a carboxy-functional acrylic resin co-cured with an epoxy resin, or a carboxy-functional polyester co-cured with a glycidyl-functional acrylic resin. More usually, however, such mixed binder systems are formulated so as to be cured with a single curing agent (for example, use of a blocked isocyanate to cure a hydroxy-functional acrylic resin and a hydroxy-functional polyester). Another preferred formulation involves the use of a different curing agent for each binder of a mixture of two polymeric binders (for example, an amine-cured epoxy resin used in conjunction with a blocked isocyanate-cured hydroxy functional acrylic resin). Other film-forming polymers which may be mentioned include functional fluoropolymers, functional fluorochloropolymers and functional fluoroacrylic polymers, each of which may be hydroxy-functional or carboxy-functional, and may be used as the sole film-forming polymer or in conjunction with one or more functional acrylic, polyester and/or epoxy resins, with appropriate curing agents for the functional polymers. Other curing agents which may be mentioned include epoxy phenol novolacs and epoxy cresol novolacs; isocyanate curing agents blocked with oximes, such as isophorone diisocyanate blocked with methyl ethyl ketoxime, tetramethylene xylene diisocyanate blocked with acetone oxime, and DESMODUR W (dicyclohexylmethane diisocyanate curing agent) blocked with methyl ethyl ketoxime; light-stable epoxy resins such as SANTOLINK LSE 120, supplied by Monsanto; and alicyclic polyepoxides, such as EHPE-3150 supplied by Daicel.

The curing agent must be present in an amount sufficient to cure the powder coating composition of the present invention. The crosslinking or curing agent typically is present in the powder coating composition in an amount from at least 5 percent by weight, preferably at least 10 percent by weight, more preferably at least 15 percent by weight, and even more preferably at least 20 percent by weight based on the total weight of the powder coating composition, and typically it is present an amount less than 90 percent by weight, preferably less than 70 percent by weight, more preferably less than 50 percent by weight, and even more preferably less than 25 percent by weight based on the total weight of the powder coating composition. The amount of the crosslinking agent present in the powder coating compositions of the present invention be in a range of any combination of these values inclusive of the recited values.

Any of the conventional additives may be used in the powder coating compositions. Such additives include, but are not limited to, fillers (particularly silica or alumina); plasticizers, flow additives and leveling agents, anti-blocking agents, slip additives, fluidizing agents degassing agents, catalysts, antioxidants, hindered amine light stabilizers and ultraviolet light absorbers. US Patent Application Publication 2004/0110876 A1 lists many examples of stabilizers and antioxidants for powder coatings.

In certain embodiments, the powder coating composition contains one or more pigments or dyes. Examples of pigments which can be used are inorganic pigments such as zinc oxide, zinc sulfide, lithopone, titanium dioxide, black iron oxide, red iron oxide, yellow iron oxide, chrome pigments, antimony white, red lead, cadmium yellow, barium sulfate, lead sulfate, barium carbonate, white lead, alumina white, and carbon black; and organic pigments such as, for example, azo pigments, polycondensation azo pigments, metal complex azo pigments, benzimidazolone pigments, phthalocyanine pigments (blue, green), thioindigo pigments, anthraquinone pigments, flavanthrone pigments, indanthrene pigments, anthrapyridine pigments, pyranthrone pigments, isoindolinone pigments, perylene pigments, quinacridone pigments, isodibenzanthrone pigments, triphendioxane pigments, perinone pigments, quinacridone pigments, vat dye pigments and lakes of acid, basic and mordant dyestuffs. Dyes can be used instead of or as well as pigments.

The powder coating materials may additionally comprise further inorganic fillers, for example titanium oxide, barium sulfate and silicate-based fillers, such as talc, kaolin, magnesium-silicates, aluminum silicates, mica and the like. The powder coatings may, furthermore and if desired, also include auxiliaries and additives.

Flexibilizing agents such as solid plasticizers, rubber, hydroxyl or acid functional polyester, styrene maleic anhydride and polyanhydride resins are used to provide a finish with more flexibility. Examples of useful plasticizers may include sucrose benzoate, pentaerythritol tetrabenzoate and cyclohexanedimethanol dibenzoate. Examples of useful rubber may include natural and most synthetic rubbers, such as styrene-butadiene and acrylonitrile-butadiene polymers. Examples of useful polyesters may include those formed by the condensation reaction of aliphatic polyols, including cycloaliphatic polyols, with aliphatic and/or aromatic polycarboxylic acids and anhydrides. Examples of suitable aliphatic polyols may include 1,2-ethanediol, 1,3-propanediol, 1,4-butanediol, 1,6-hexanediol, neopentyl glycol, cyclohexane dimethanol, trimethlyopropene, and the like. Examples of suitable polycarboxylic acids and anhydrides may include succinic acid, adipic acid, azelaic acid, sebacic acid, terephthalic acid, isophthalic acid, tetrahydrophthalic acid, hexahydrophthalic acid trimellitic acid, and anhydrides of such acids. The flexibilizer, if needed, may be present up to 50%, preferably, from about 5% to about 30% by weight in the composition.

The powder coating composition may be produced by conventional methods. Typically, the combined components may be subjected to heating, melting, mixing and kneading by the use of an extruder, screw compounder, or other mixing device, and subjecting the mixed product to cooling, grinding and classification. The extrudate is immediately cooled and then is grounded in a mill, such as a Brinkman mill, a Bantam hammer mill, an Alpine Mill or an ACM Mill, and sieved to obtain a powder of appropriate particle size depending on the application. Although a wide range of particle sizes may be useful in the powder coating compositions of the invention, typical average particle sizes are from about 5 to about 250 microns. Preferably, the average particle size of the powder coating composition of the invention is from about 10 microns to about 80 microns, and more preferably, from about 20 to 30 microns.

The laser-reactive additive or additives may be added to the powder coating composition in the mixing device to be melt-mixed together with the other powder coating components. Alternatively or in addition, the laser-reactive additive may be dry-blended with the formed, pigmented powder coating composition when the laser-reactive additive is of a suitable particle size, particularly a particle size similar to that of the powder coating composition.

The powder coating compositions of the present invention may be applied to an article by conventional methods. Such methods include electrostatic coating processes and fluidized bed coating processes.

In one preferred embodiment, application comprises applying a powder coating composition by an electrostatic spray coating process, and heating the applied composition to melt and fuse the particles and cure the coating. The electrostatic spray coating process may be a corona charging or tribo charging process. In the case of a tribo charging process, it is recommended that the powder coating composition should be one that has been formulated especially for such application, for example, by the use of suitable polymers of which the so-called “tribo-safe” grades are an example or by the use of additives which can be introduced prior to extrusion in a manner known per se.

The thickness of the cured powder coating layer may vary depending on the article to which it is applied and performance requirements, but will generally range from about 1.0 mil to about 8.0 mils, in certain embodiments preferably from about 1.0 to 4.0 mils, and in certain embodiments from about 1.5 to 2.5 mils cured coating.

The substrate may be a metal, such as steel, galvanized steel or iron, or may be a plastic. The substrate may already have a coating layer on it before the coating layer with the laser-reactive material is applied.

Curing may be achieved by heating the coated article at a temperature for a time sufficient to cure the composition. The article may be heated with infrared light. Cure temperatures of from about 150 to 200° C. are generally suitable, with cure schedules of from about 150 to 180° C. for about 10 to 30 minutes being typical. It will be appreciated that the cure time varies depending on the cure temperature, the nature and the thickness of the substrate. Cure time can be much shorter for a metal article heated with infrared lamps.

After the powder coating layer is formed on the article, a laser beam is directed onto the areas of the coating where the marking is desired. The type of laser is selected to cause the coating containing the laser-reactive additive to change color or shade. In general, the laser may be a carbon dioxide, neodymium-YAG laser, or pulsed fiber laser. In general, kaolins, chalks, aluminas, phyllosilicates, and micas react well with carbon dioxide lasers, while a Nd-YAG laser may be used with metallic and pearlescent pigments, metal oxide-coated micas, and antimony (III) oxide. The determination of the optimum laser-reactive additive, its level in the powder coating, and the laser type may be made by straightforward experimentation. An Nd-YAG laser is particularly good for marking with high definition.

The laser beam is directed onto the areas of the powder coating where a marking is desired for a length of time sufficient to cause the desired color change or shade shift in the coating. The marking speed may be as high as about 190 inches per second, depending on factors such as coating color, amount and type of laser reactive material in the coating layer. The laser marking system generally includes a laser marking head, system control system, blades that are located in a fixture on a conveying device that passes the parts under the laser for marking. Movement of the laser beam on the coating surface may be controlled by a steering system that sweeps the laser beam using computer-controlled mirror, or galvanometers, to move the beam in two dimensions. The laser path is programmed into a CPU, which controls the steering system, so avoiding the need to make a mask or screen. Suitable controlled laser systems are commercially available from Kevron Inc., Microtrace, Keyance America, Rofin-Baasel, Inc. Crontrol Microsystems, FOBA Laser systems, and Preco Industries. Diode-pumped YAG lasers with power ranges of 3 to 100 W replace lamps with a diode array as the laser light source and may be air-cooled.

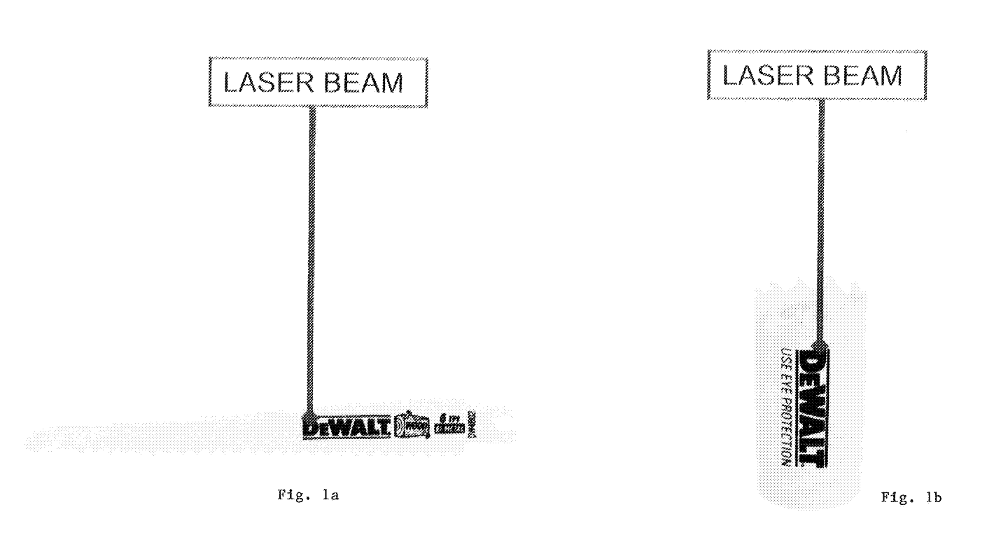

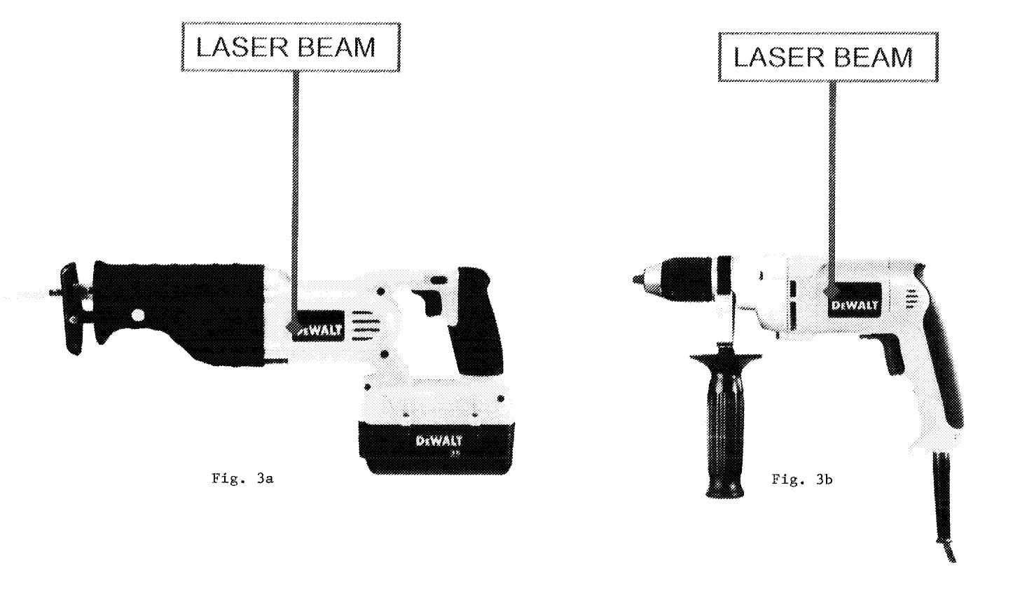

FIG. 1a illustrates a graphic produced by laser marking a yellow powder-coated steel saw blade. FIG. 1b illustrates a graphic produced by laser marking a yellow powder-coated steel hole saw blade. FIGS. 3a and 3b illustrate graphics and information marked with a laser beam on plastic housings for, respectively, a reciprocating saw and a drill coated with yellow powder coating.

In a second method, an article is marked with a laser beam as already described, except that the powder coating composition either contains no colorant (pigment or dye) other than the laser-reactive additive, or that only such colorant is included as allows the powder coating composition to form a transparent coating layer on the article. Such powder coatings are often referred to in the art as “clear” powder coatings. The powder coating composition may otherwise have the same composition, and be made in the same way, as the powder coating composition used in the first method. In this method, the clear powder coating composition containing the laser-reactive additive may be applied over an uncoated substrate or may be applied over an already-coated substrate. The clear powder coating layer formed therefrom may be marked in the same way as in the first method.

The clear powder coating may be applied to an article over another coating layer. The coating layer may be cured before the clear powder coating containing the laser-reactive material is applied over it. In another embodiment of the method, the clear powder coating containing the laser-reactive material is applied in a thin layer over a cured coating on an article or after a coating composition is applied to the article but before baking or curing of the coating composition. The clear powder coating layer and underlying coating composition layer are then baked together to cure each layer. The coating layer under the clear powder coating layer may be colored.

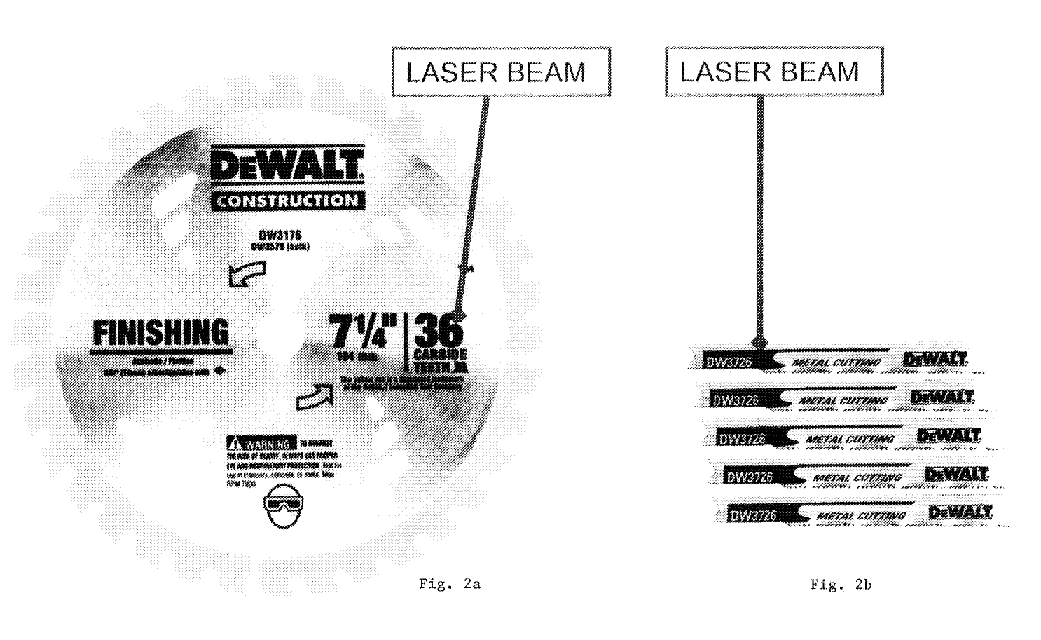

FIGS. 2a and 2b illustrate graphics and information marked with a laser beam on, respectively, a circular saw blade and steel jig saw blades coated with clear powder coating.

In another embodiment, the laser-reactive material is incorporated into a liquid composition. The liquid composition may be curable and may contain polymers and crosslinkers as described above for the powder coating. The liquid composition may also be thermoplastic; that is, it may omit any crosslinker. The liquid composition additionally includes water, one or more organic solvents, or a combination of water and a water-soluble organic solvent. Suitable examples of organic solvents include, without limitation, esters, ketones, ethylene glycol monoalkyl ethers and propylene glycol monoalkyl ethers, alcohols, and aromatic hydrocarbons such as xylene, toluene, and Aromatic 100.

The liquid composition containing the laser-reactive material in a thin layer over a cured coating on an article or after a coating composition is applied to the article but before baking or curing of the coating composition. In particular embodiments, the coating over which the liquid composition is applied is a powder coating. The powder coating may be as described above, but without including a laser-reactive material. If applied over an uncured coating composition, the coating composition is then cured. The article is then marked with a laser beam in the area where the composition containing the laser-reactive material was applied. The layer thicknesses may be the same as those for the powder coating embodiment, but the liquid composition may be applied by any of the typical coating methods, including spray coating, dip coating, roll coating, curtain coating, knife coating, and the like.

The invention is further described in the following examples. The examples are merely illustrative and do not in any way limit the scope of the invention as described and claimed. All parts are parts by weight unless otherwise noted.

### COMPARATIVE EXAMPLE 1

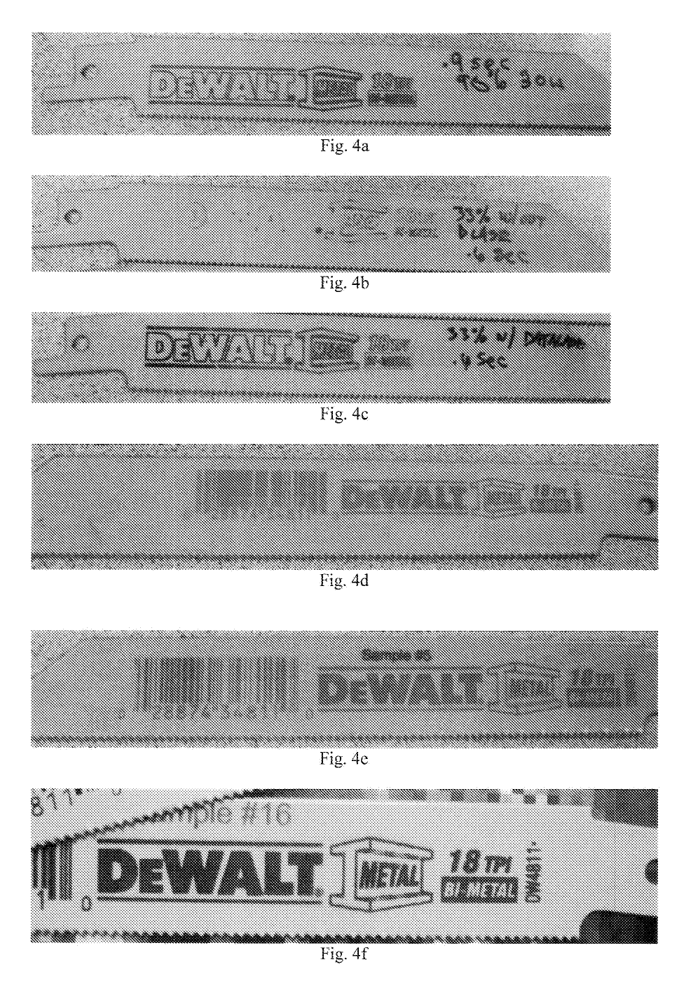

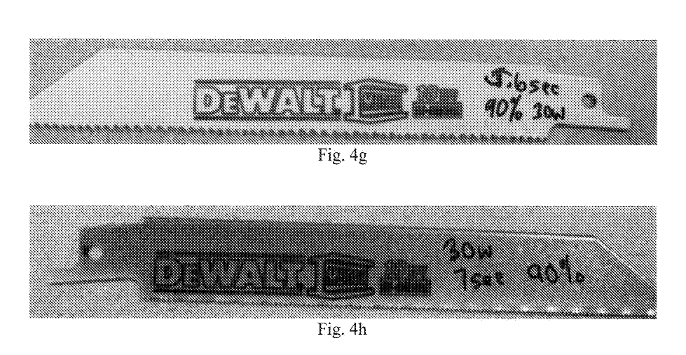

A strip of steel is processed in a machine that grinds or mills teeth into one edge of the steel strip. The strip is then run through a press that punches out the blade shape from the strip of steel. The blade is then heat treated in special furnaces to turn the steel material hard and tough. A yellow powder coat polyester epoxy hybrid with NO additives is then sprayed onto the blade and cured for 1 minute at 475 deg F. in a pass-through IR oven. The powder coating has a thickness of 3-5 mils. The cured powder coating is marked using a CO₂ laser, 30W, at 90% power, 0.9 sec exposure. The color is not correct. The result is shown in FIG. 4a.

### COMPARATIVE EXAMPLE 2

Comparative Example 1 is repeated, except that the cured powder coating is marked using a CO₂ laser, 30W, at 33% power, 0.6 sec exposure. The mark is incomplete and the color is not correct. The result is shown in FIG. 4b.

### EXAMPLE 1

The procedure of Comparative Example 1 is repeated, using a yellow, polyester epoxy hybrid powder coating composition containing a laser-reactive additive (available from DataLase) at about 5% by weight. The cured powder coating is marked using a CO₂ laser, 30W, at 33% power, 0.4 sec exposure. The mark is dark. The result is shown in FIG. 4c.

### COMPARATIVE EXAMPLE 3

The procedure of Comparative Example 1 is repeated, using a yellow, polyester epoxy hybrid powder coating composition without any laser-reactive additive. The cured powder coating is marked using a YAG 30W at 85% power, 103 sec exposure. The mark is light. The result is shown in FIG. 4d.

### EXAMPLE 2

The procedure of Example 1 is repeated, using a yellow, polyester epoxy hybrid powder coating composition containing a laser-reactive additive (available from Mark-It) at about 1% by weight. The cured powder coating is marked using a Laser Pulsed Fiber 30W at 100% power, 18.65 sec exposure. The mark is light. The result is shown in FIG. 4e.

### COMPARATIVE EXAMPLE 4

The procedure of Comparative Example 1 is repeated, using a yellow, polyester epoxy hybrid powder coating composition without any laser-reactive additive. The cured powder coating is marked using a Laser Pulsed Fiber 30W at 100% power, 240 sec exposure. The mark is light. The result is shown in FIG. 4f.

### COMPARATIVE EXAMPLE 5

The procedure of Comparative Example 1 is repeated, using a white, polyester epoxy hybrid powder coating composition without any laser-reactive additive. The cured powder coating is marked using a CO₂ laser, 30W at 90% power, 5.6 sec exposure. The mark is grey. The result is shown in FIG. 4g.

### EXAMPLE 3

The procedure of Comparative Example 1 is repeated, using a white, polyester epoxy hybrid powder coating composition with metallic aluminum flake pigment as the laser-reactive additive. The cured powder coating is marked using a CO₂ laser, 30W at 90% power, 7 sec exposure. The mark is a good, dark color. The result is shown in FIG. 4h.

The invention has been described in detail with reference to preferred embodiments thereof. It should be understood, however, that variations and modifications can be made within the spirit and scope of the invention and of the following claims.

What is claimed is:

1. A method of marking an article, comprising
incorporating into a powder coating composition a laser-reactive material;
forming a coating layer on an article with the coating composition, and
marking the coating on the article with a laser.

2. A method according to claim 1, wherein the laser-reactive material is incorporated during preparation of the powder coating composition.

3. A method according to claim 1, wherein the laser-reactive material is incorporated by dry-blending with a previously prepared powder coating composition.

4. A method of marking an article, comprising
incorporating into a clear powder coating composition a laser-reactive material;
forming a coating layer on an article with the coating composition, and
marking the coating on the article with a laser.

5. A method according to claim 4, wherein the laser-reactive material is incorporated when the powder coating composition is prepared.

6. A method according to claim 4, wherein the laser-reactive material is incorporated by dry-blending with a previously prepared powder coating composition.

7. A method according to claim 4, wherein the article comprises a colored coating layer over which the coating layer of the clear powder coating composition is formed.

8. A method according to claim 7, wherein the clear powder coating composition is applied over an uncured colored coating layer, and then the colored coating layer is cured.

9. A method according to claim 8, wherein the colored coating layer is a colored powder coating layer.

10. A method of marking an article, comprising
coating the article with a layer of powder coating;
applying in an area over the layer of powder coating a composition comprising a laser-reactive material; and
marking the article with a laser beam in the area where the composition comprising a laser-reactive material was applied.

11. A method according to claim 10, wherein the composition comprising a laser-reactive material is a powder coating composition.

12. A method according to claim 10, wherein the composition comprising a laser-reactive material is a liquid composition.

13. A method according to claim 10, wherein the layer of powder coating is cured before the composition comprising a laser-reactive material is applied.

14. A method according to claim 10, wherein the layer of powder coating is cured after the composition comprising a laser-reactive material is applied.

15. A method according to claim 10, wherein the powder coating is colored.

16. A method of marking an article, comprising
applying a liquid composition comprising a laser-reactive material in an area of a coated article; and
marking the article with a laser beam in the area where the composition comprising a laser-reactive material was applied.

17. An article prepared by the method of claim 1.

18. An article prepared by the method of claim 10.

19. An article prepared by the method of claim 16.
